(19) United States
(12) Patent Application Publication
(10) Pub. No.: US 2020/0222823 A1
(43) Pub. Date: Jul. 16, 2020

(54) Face, head, or body costume reflection mirror cling

(71) Applicant: Carmen Lynn Abraham, Highlands Ranch, CO (US)

(72) Inventor: Carmen Lynn Abraham, Highlands Ranch, CO (US)

(21) Appl. No.: 16/107,659

(22) Filed: Aug. 21, 2018

(30) Foreign Application Priority Data
Oct. 17, 2017 (US) 62574663

(51) Int. Cl. A63J 7/00; G02B 5/08

(52) U.S. Cl. CPC A63J 7/005; A41G 7/00; G02B 5/08

(57) ABSTRACT

The present invention comprises a novel mirror cling product generally consisting of a sheet or multiple sections and that is capable of adhering to a mirror or similar smooth surface for the purpose of viewing a reflection through the image(s) printed on the said product.

### BACKGROUND/FIELD OF THE INVENTION

The invention relates to products with images that adhere to a surface for play or inspiration. More particularly the invention is capable of creating a reflection(s) from a mirrored surface using static cling vinyl or similar material with graphic images to reflect images back at the user. The invention creates an illusion to the person viewing that they are actually wearing the image(s) on the cling invention as a costume when they view their reflection.

### SUMMARY OF THE INVENTION

The product allows the user to adhere the product to mirrors or similar smooth surfaces with static cling vinyl with or without light adhesive or any other re-moveable and re-useable similar material. The graphics may take on any form including drawings, pictures, letters, words, or any combination in multi-color or black and white.

Mirror decorative system providing viewing and reflecting of a background element such as but not limited to a person's face through a frame, mask, or head gear structure graphic(s).

### BRIEF DESCRIPTION OF THE DRAWINGS

The embodiments of the present invention are illustrated as an example and are not limited by the figures of the accompanying drawings.

FIG. 1 illustrates a front perspective view of one example of a mirror cling that includes separate images used as a set.

FIG. 2 illustrates a front perspective view of a second example of the invention that includes one large image.

FIG. 3 illustrates the top layer of the invention that includes the graphic image and the second later that is the backing sheet of the invention.

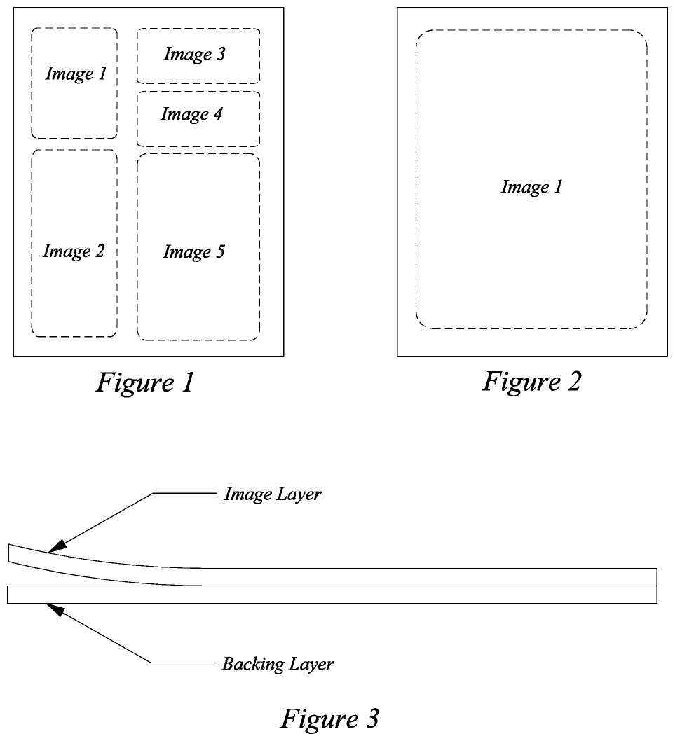

### DETAILED DESCRIPTION

The terminology used herin is for the purpose of describing the invention and is not intended to be limiting.

Removable and re-useable vinyl sheet(s) with images and including a backing material sheet layered under said vinyl layer sheet and removable. Retained by static cling or similar material with or without the use of adhesives between. May be removed and repositioned.

Can be one piece or a group of images used as a set.

When the image sheet is removed from the backing sheet, it may be placed on any flat smooth surface, such as a mirror or glass window pane, as long as the material with or without adhesive can hold the removable vinyl layer sheet to the surface.

A reusable system which includes flexible static cling vinyl or similar material. The graphic sheet is offered in a plurality of shapes and forms for the purpose of creating images. The graphics are peeled from the backing sheet and applied to a mirror or similar smooth surface in one piece or in combinations.

Examples: an astronaut helmet; rabbit face including ears, nose, whiskers. Although the present invention has been illustrated and described with reference to preferred embodiments and specific examples, it will be readily apparent to those of ordinary skill in the art that other embodiments and examples may perform similar functions or achieve like results. All such equivalent embodiments and examples are within the spirit and scope of the present invention, and are intended to be covered by the application.

1. An apparatus for viewing a reflection through a decal face, head, or body costume comprising:
(a) an image printed on static cling vinyl or similar material when placed on a mirror or similar reflective surface part of your face, head or body is viewed through the image;
(b) Removable backing material such as paper; and
(c) Reusable static cling vinyl or similar material.
